(19) United States
(12) Patent Application Publication
(10) Pub. No.: US 2019/0327963 A1
(43) Pub. Date: Oct. 31, 2019

(54) NON-IRRITATING ANTIMICROBIAL COMPOSITIONS AND METHODS OF USE

(71) Applicant: Purdue Research Foundation, West Lafayette, IN (US)

(72) Inventor: Jianming Li, Lafayette, IN (US)

(21) Appl. No.: 16/503,067

(22) Filed: Jul. 3, 2019

Related U.S. Application Data
(63) Continuation-in-part of application No. 14/775,865, filed on Sep. 14, 2015, now Pat. No. 10,383,330.
(60) Provisional application No. 61/794,661, filed on Mar. 15, 2013.

(51) Int. Cl. A01N 31/08; A01N 25/04; A01N 27/00; A01N 35/02; A01N 37/10; A01N 43/16; A01N 31/16; A01N 31/06; A01N 35/06; A01N 31/02; A01N 25/30

(52) U.S. Cl. CPC A01N 31/08; A01N 25/04; A01N 27/00; A01N 35/02; A01N 37/10; A01N 25/30; A01N 31/16; A01N 31/06; A01N 35/06; A01N 31/02; A01N 43/16

(57) ABSTRACT

Certain embodiments of the invention relate to antimicrobial emulsions for use as surface disinfectants, oral cleansers, wound dressings, agricultural and industrial sanitizers. The emulsions may include stable alcohol-free or reduced alcohol emulsions based on naturally derived plant phenolics. The emulsions may use edible surfactants at ultra-low concentrations, are non-irritating and possess rapid, high antimicrobial activity against a host of pathogenic microorganisms. Such properties permit the use of these emulsions in health care and in applications involving food preparation.

### CROSS-REFERENCE TO RELATED APPLICATIONS

This application is a continuation-in-part of U.S. patent application Ser. No. 14/775,865, filed Sep. 14, 2015, which claims the benefit of International Patent Application PCT/US2014/025752, filed on Mar. 13, 2014, which claim priority to U.S. Provisional Application No. 61/794,661, filed Mar. 15, 2013, each of which is incorporated herein by reference in their entirety.

### STATEMENT REGARDING FEDERALLY SPONSORED RESEARCH OR DEVELOPMENT

Not applicable.

### FIELD OF THE INVENTION

This invention relates to antimicrobial compositions based on thymol and other essential oil derivatives. More specifically, the invention relates to sub-micron and micron emulsions that include the use of edible surfactants to stabilize the emulsion droplets. The emulsions are non-toxic and demonstrate rapid antimicrobial activity that make the emulsions suitable for both biologic and non-biologic surface disinfection applications.

### BACKGROUND

There exists a significant need for safe, non-irritating antimicrobial compositions that do not rely on harsh synthetic chemicals or antibiotics. In recent decades, the persistence of these artificial antimicrobial compounds has created global health concerns regarding the long-term safety of these compositions on human tissue as well as to environmental systems. Many of these compositions are toxic to humans when directly applied to skin or mucosal membranes in the skin, oral cavity, intestinal tract, and lungs (e.g., through inhalation). Exposure to some antimicrobial compositions may have serious, long-term health consequences. Further, some synthetic antimicrobial compounds may leave harmful residues on applied surfaces. These biocides include chlorinated compounds, peroxides, and/or quaternary ammonium compounds, all of which may pose toxicity concerns when deposited on food or on food contacting surfaces. Such drawbacks limit the dosage and use of these biocides, especially in healthcare and in food preparation.

In contrast, natural based antimicrobial agents, such as those derived from plants, offer an alternative to synthetic antimicrobial compounds. For example, essential oils (e.g., thyme oil, oregano oil, clove oil, mint oil, etc.) or their active components have been used in many applications such as antimicrobial wound dressings, mouthwashes, and agricultural fungicides due to their safety profile and rapid biodegradation in the environment. However, the water insolubility of these essential oils and respective derivatives present challenges for widespread adoption. Organic solvents such as alcohols have been traditionally used to dissolve essential oil compounds for use. Alternatively, oil-in-water emulsions have been used to deliver essential oils in aqueous forms. However, some of these solvents are toxic and may dehydrate biologic tissues or are viewed negatively by consumers. Further, a severe limitation of emulsion carrier systems is that they are formulation specific and may alter unpredictably the stability and antimicrobial activity of the essential oils. This antagonism is not well understood and unexpected as many surfactants are themselves antimicrobial due to their lipid disrupting properties. This demonstrates that surfactant selection for essential oil emulsion formulation is a brute force screening approach. Since there are thousands of surfactant types and concentrations to choose from, the surfactant delivery system is of upmost importance in satisfying the stability and antimicrobial specifications set forth by regulatory bodies such the United States Food and Drug Administration.

Previous attempts to mitigate some or all of these problems have found little success. For example, U.S. Pat. No. 6,585,961 to Stockel et al. discloses an invention of essential oils in which the emulsion droplets are less than 50 nm using surfactant concentrations at levels of from 0.75% to 2.0% by weight of the composition. And U.S. Pat. No. 6,585,961 to Bae et al. discloses an invention in which thymus or taxus extract is suspended using oil, solvent, and an emulsification system comprising greater than 1.1% of the composition by weight.

However, these emulsions use high concentrations of antimicrobial compounds or surfactant levels that may cause irritation or dermal sensitivity. Further, these inventions also use surfactants at levels higher than the critical micelle concentration, which is known in the art as an established principle to stabilize the droplets. The use of such high levels of surfactant may inhibit antimicrobial efficacy, especially when very rapid inactivation (<30 seconds) is required. And even if these compositions may be effective at 5-10 minutes working time, they may not be sufficient to inactivate pathogens at a 30 second time interval.

Accordingly, there is a need in the art for emulsions based on natural antimicrobial products having improved stability and water miscibility, while retaining effective levels of antimicrobial activity. The present invention addresses that need.

### SUMMARY OF THE INVENTION

The invention relates to a new class of ultra-low surfactant and non-toxic antimicrobial emulsions comprising an active component such as thymol and/or other plant derived aromatic compounds, a surfactant, an organic co-solvent, and water.

Certain preferred embodiments of the invention provide stable submicron and micron sized emulsions that may comprise thymol and/or one or more essential oil derivatives, an edible surfactant, a droplet stabilizer, and water in which the active components are stabilized by a combination of surfactants and non-surfactant emulsion stabilizers (i.e., droplet stabilizers). These stabilizers may inhibit creaming, sedimentation and coalescence of emulsion droplets.

The active component may be selected from monoterpenoids and polyphenols. In preferred embodiments of the invention, the active component includes at least thymol and may include also one or more of carvacrol, menthol, menthone, eugenol, cymene, p-cymene, limonene, geraniol, terpineol, eucalyptol, and citral.

In certain preferred embodiments of the invention, the surfactant may be a non-ionic surfactant or an anionic surfactant. In certain embodiments, the surfactant is selected from polyoxyethylene glycols, polyoxypropylene glycols, glucosides, polyoxyethylene glycol octylphenol ethers, polyoxyethylene glycol alkylphenol ethers, glycerol alkyl esters, polysorbates, sorbitan esters (spans), cocamides, poloxamers, polyethoxylated tallow amines, sodium dodecyl sulfate (sodium lauryl sulfate), ethoxylated sodium lauryl sulfate (sodium laureth sulfate), and combinations thereof. In certain preferred embodiments, the emulsions includes a total active component (e.g., thymol plus additional active compounds) and surfactant ratio in the range of from about 1:5 and about 30:1, preferably from about 10:1 to about 3:1, and more preferably, from about 5:1 to about 3:1 by weight of the emulsion.

In certain preferred embodiments, the concentration of the surfactant in the emulsion is from about 0.0015% to about 0.1%. The use of such low concentrations of surfactant offers numerous advantages, including providing a product having a less soapy feel or texture, reducing the risk of skin irritation, contact dermatitis, and allergic reactions. For example, many surfactants in cosmetic and/or pharmaceutical use may cause skin irritation and/or other allergic reactions. Further, the probability for contact dermatitis may be minimized substantially by reducing the surfactant concentration. And economically, the low amounts of surfactant may reduce cost of product manufacturing.

In certain embodiments, the antimicrobial emulsions may be provided in a concentrated form for dilution prior to use. Such concentrated formulations may be used without prior dilution, but retain the same ratio of active component and surfactant as the ready to use formulation (e.g., the concentration of active component and surfactant present in ratios in the range of from about 1:5 to about 30:1 by weight.)

In certain embodiments of the invention, the antimicrobial emulsion may include an organic co-solvent such as an organic polar co-solvent. In certain embodiments, the organic co-solvent is a short chain alcohol (e.g., methanol, ethanol, or butanol), a carboxylic acid (e.g., acetic acid or citric acid), acetone, methyl ethyl ketone, chloroform, DMSO, or an ether.

The emulsion may have, in certain embodiments, an average emulsion particle or droplet size in the range of from about 25 nanometers (nm) to about 3000 nm.

The antimicrobial emulsions of the present invention may be used in any method in which reduction in microorganisms is desired. The methods involve contacting an object with an effective amount of an antimicrobial emulsion to reduce the amount of microorganisms on the object. In some embodiments of the invention, an effective amount of antimicrobial emulsion reduces the number of microorganisms on the contacted object by a factor of greater than or equal to a 3-log reduction of microorganisms within about 30 seconds. Advantageously, the antimicrobial emulsions may be used to disinfect hard surfaces, including, but not limited to, medical tools and devices, durable medical equipment, floors, walls, cutting boards, countertops, tabletops, toilet bowls, showers and bathtubs. The antimicrobial emulsions may be used to disinfect food items, such as fruits, vegetables, including, for example, leafy green vegetables, and the shell of eggs. The antimicrobial emulsions may be part of or used as cleaning solutions, disinfectants, sanitizers, antiseptics, wound care preparations, agricultural sprays or rinses, fruit and vegetable sprays for home use, and personal care products. The antimicrobial emulsions may be used in personal care products such as cosmetics, antifungal creams, wound care preparations, toothpaste, oral rinses, and denture care products. Such products containing the antimicrobial emulsions may be provided to the end user in a concentrated form or in a pre-diluted, ready-to-use form.

Embodiments of the invention address many of the challenges associated with essential oil emulsions by using, inter alia, a novel stabilizer system along with ultra-low surfactant concentrations. Traditionally, such low-surfactant systems are difficult to stabilize and often phase separate prematurely. The disclosed invention employs unique stabilization techniques that satisfy the requirements of low-toxicity and high antimicrobial efficacy. The emulsions are highly stable and possess low viscosity that is amenable for use in sprays and nebulizers. Further, the reduced surfactant level significantly reduces dermal irritation effects and sensitization. In some cases, the amount of surfactant used is below the critical micelle concentration (CMC). In other embodiments, organic solvents may be significantly reduced or completely omitted from the formulations.

It is an advantage of the antimicrobial formulations of the invention that that the active components display improved solubility in aqueous solutions.

Another advantage of the antimicrobial formulations of the present invention is that the emulsion particles or droplets have a low polydispersity index (PDI). In certain embodiments, the PDI is in the range of from about 0.1 to about 0.5

It is a further advantage that the emulsions are relatively stable, even after being subjected to moderate heat treatment, freeze-thaw cycles, or centrifugation.

It is an advantage that the antimicrobial emulsions are effective against a wide range of pathogens, including both gram positive and gram negative bacteria, antibiotic resistant bacteria, yeast and viruses.

It is a further advantage that certain emulsion formulations of the invention are effective in killing pathogenic microorganisms by 99.9% or more in 30 seconds.

It is a further advantage that the active component of the antimicrobial formulation is a natural product of very low toxicity.

It is an advantage that the antimicrobial emulsion formulations of the invention are effective against planktonic microorganisms and biofilms.

It is a further advantage that the emulsions of the antimicrobial formulations may be manufactured via standard homogenization techniques or, preferably, via spontaneous emulsification (self-assembly) through the use of an organic co-solvent.

The present invention and its attributes and advantages will be further understood and appreciated with reference to the detailed description below of presently contemplated embodiments and drawings.

### BRIEF DESCRIPTION OF THE DRAWINGS

FIG. 1 is a transmission electron micrograph of a nanoemulsion comprising Tween 20 and thymol in a ratio of 1:10, and having an average droplet size of about 135 nm.

FIG. 2 is a transmission electron micrograph showing the mechanism of action of thymol based emulsions in which membrane emulsification and lysis of E. coli was evident at a thymol concentration of 0.10%.

FIG. 3 is a graphical illustration of the change in efficacy of an emulsion against Staphyloccocus aureus as a function of surfactant level.

FIG. 4 is a graphical illustration of the change in efficacy of an emulsion against Candida albicans as a function of surfactant level.

### DETAILED DESCRIPTION

There exists a need for new types of natural antimicrobial formulations that are stable, water soluble, retain antimicrobial activity, and/or possess physical characteristics suitable for consumer and/or industrial use such as water soluble aqueous formulations that may be compatible with existing industrial and/or medical protocols. Such formulations may reduce the inappropriate and/or overuse of antibiotics, for example in the agricultural and/or medical fields. The term “antimicrobial”, as used herein, describe the ability to inactivate and/or kill greater than or equal to about 99% of microbial pathogens, such as Gram-positive and/or Gram-negative bacteria, fungus, spores and/or viruses, in an unspecified timeframe. “Antiseptics” and “sanitizers” are defined as killing greater than or equal to 99.9% of microbial pathogens within about 10 minutes or less, as specified by some U.S. government performance standards.

In certain embodiments, the invention provides formulations comprising emulsions that include one or more active antimicrobial compounds including, for example, active antimicrobial compounds derived from essential oils. The antimicrobial compound or “active component”, may include aromatic phenols derived from essential oils. These antimicrobial compounds may be obtained naturally (extracted) from their origins (e.g., from a plant) or synthetically manufactured. In certain embodiments, the active component may include one or more monoterpenoid and/or one or more polyphenols.

In some embodiments, the active component may include a single compound such as thymol or a combination of thymol with other active components such as, for example, carvacrol, menthol, menthone, eugenol, cymene, p-cymene, limonene, geraniol, terpineol, eucalyptol, methyl salicylate, citral, or the like, and combinations thereof. To maintain the safety profile of the formulations, preferably the total concentration of active component is 1% or less. Formulations of emulsions may be free or substantially free of carrier oils and/or additional preservatives.

Formulations of an emulsion may include a surfactant or emulsifying agent to stabilize the active components in an aqueous media and to reduce the interfacial energy of the emulsions and to prevent phase separation. For example, an emulsion formulations may include, as a surfactant, polyoxyethylene glycols, polyoxypropylene glycols, glucosides, polyoxyethylene glycol octylphenol ethers, polyoxyethylene glycol alkylphenol ethers, glycerol alkyl esters, polysorbates, sorbitan esters (spans), cocamides, poloxamers, polyethoxylated tallow amines, and combinations thereof. In another example, the surfactant is selected from the group consisting of polyoxyethylene glycols, polyoxypropylene glycols, glucosides, polyoxyethylene glycol octylphenol ethers, polyoxyethylene glycol alkylphenol ethers, glycerol alkyl esters, polysorbates, spans, cocamides, poloxamers, and polyethoxylated tallow amines.

In other preferred embodiments of the invention, the surfactant may be an edible non-ionic surfactant or an anionic surfactant. Preferably, the edible non-ionic surfactant is selected from the group of polysorbates, glucosides, polyoxyethylene glycol octylphenol ethers, polyoxyethylene glycol alkylphenol ethers, glycerol alkyl esters, polysorbates, sorbitan esters (spans), cocamides, lecithin, sodium dodecyl sulfate (sodium lauryl sulfate), ethoxylated sodium lauryl sulfate (sodium laureth sulfate), and combinations thereof. In preferred embodiments of the invention, the edible surfactant is a polysorbate or sodium lauryl sulfate. Optionally, one or more additional surfactants, that is, a co-surfactant, may be used to further stabilize the emulsions.

Preferably, the total surfactant concentration may be less than 0.1% by weight, and preferably 0.04 to 0.1% by weight in order to reduce possible irritation to mucosal membranes and skin. Lower surfactant levels may be beneficial by producing a less soapy feel to the product. Further, lower surfactant formulations are also more environmentally friendly, as they are less toxic to aquatic life forms and soil microbiomes during runoff. However, a surfactant concentration that is too low may result in unstable emulsions. Therefore, other parameters such as the active component to surfactant ratio and the presence of co-stabilizers may be important when formulating ultra-low surfactant emulsions. For example, the ratio of active component to surfactant is an important effect related variable. This invention describes emulsions in which the active component concentration is higher than the surfactant. This allows the antimicrobial emulsions to maintain the strong antimicrobial activity of the active components. At higher active component to surfactant ratios, such as those beyond a ratio of 5:1 active component to surfactant, the droplets are often unstable as there may be insufficient surfactant molecules to appropriately stabilize small droplets. At lower active component to surfactant ratios, such as a ratio of 1:1 active component to surfactant and below, the inhibitory effects of the surfactant may dominate and reduce the antimicrobial efficacy of the product. Generally, the total active component to surfactant ratio should be from about 10:1 to 3:1 and optimally from about 5:1 to 3:1.

Formulations of the emulsions may include further a co-solvent such as an organic polar co-solvent. In some embodiments, an emulsion may include as a co-solvent ethanol, methanol, acetic acid, acetone, methyl ethyl ketone, butanol, chloroform, Dimethyl sulfoxide (DMSO), ether, citric acid, or the like, and combinations thereof. In some embodiments, the formulation may include a co-solvent selected from the group consisting of ethanol, methanol, acetic acid, acetone, methyl ethyl ketone, butanol, chloroform, DMSO, ether, and citric acid. Additional co-solvents also may be used. In further embodiments of the invention, the co-solvent may be selected from ethanol, methanol, poloxamer, propylene glycol, polyethylene glycol, ethylene glycol, diols, glycols, ether, or the like, and combinations thereof. Formulations using a co-solvent may facilitate a self-assembling emulsion, e.g., an emulsion that forms spontaneously or substantially spontaneously upon combining the components of the emulsion.

In certain embodiments, the formulations and emulsions are effective against a variety of microorganisms, for example microorganisms on a target surface. The formulation may be effective against bacteria, viruses and/or fungi. In certain embodiments, formulations of the invention are effective against microorganisms including, but not limited to, Escherichia coli, Pseudomonas aeruginosa, Staphylococcus aureus MRSA strains, Enterococcus faecalis VRE strain, Candida albicans, Herpes simplex 1, or the like, and/or combinations thereof. In certain embodiments, the formulations are effective against a microorganism selected from the group consisting of Escherichia coli, Pseudomonas aeruginosa, Staphylococcus aureus MRSA strain, Enterococcus faecalis VRE strain, Candida albicans, Herpes simplex 1 virus, vancomycin resistant Staphylococcus aureus (VRSA), Norovirus, human immunodeficiency virus (HIV), Rhinovirus, Clostridium difficile, Klebsiella pneumoniae, Mycobacterium tuberculosis, Salmonella typhimurium, Listeria monocytogenes, Vibrio cholera, Propionibacterium acnes, and Trichophyton mentagrophytes.

In certain preferred embodiments, the mean emulsion particle or droplet size or diameter is in the range of from nanometers (nm) to micrometers (μm). In certain preferred embodiments, an average emulsion particle or droplet size is in the range of from about 200 nm to about 2000 nm, about 200 nm to about 900 nm, about 200 nm to about 600 nm, about 300 nanometers to about 1200 nm, or about 400 nanometers to about 1500 nm. Emulsion droplet sizes within these ranges maintain stability while reducing dermal irritation effects associated with smaller nanometer sized droplets.

In other embodiments, the mean emulsion droplet size is from about 25 nm to about 5000 nm. In some embodiments, a mean emulsion droplet size may be less than 1000 nm. In certain embodiments, the mean emulsion droplet size is from about 25 nm to about 1000 nm. In some embodiments, the mean emulsion droplet size is from about 100 nm to about 600 nm. A formulation having a mean emulsion droplet size of less than about 1000 nm may exhibit improved shelf life properties, allowing extended storage of the formulation. In some embodiments, formulations having a mean emulsion droplet size less than about 1000 nm may be advantageous. For example, formulations having such droplet sizes may be more easily distributed in an emulsion. Formulations having a mean emulsion droplet size less than about 1000 nm may facilitate a self-assembling emulsion, e.g., an emulsion that forms spontaneously or substantially spontaneously upon combining the components of the emulsion. In some embodiments, formulations having a mean emulsion droplet size less than about 1000 nm exhibit improved antimicrobial properties, for example, having improved ability to penetrate the skin and/or rough surface patches. A formulation having a mean emulsion droplet size less than about 1000 nm may have reduced viscosity, relative to formulations having larger mean emulsion droplet sizes. Formulations having reduced viscosity may be suitable for certain antimicrobial applications, including sprays, wipes, cleansers, flushes, wound preparations, and/or other similar applications.

A mean emulsion particle size may be controlled and/or filtered to satisfy different end user requirements. In some embodiments, a mean particle size may be controlled at least in part by a composition of the formulation. For example, formulations having compositions as described herein may exhibit mean emulsion droplet sizes suitable for a variety of applications. In some embodiments, formulations of emulsions having compositions as described herein may provide, for example, desirable shelf life properties and/or antimicrobial properties. These include formulation of emulsions having a composition as described herein may have a mean emulsion droplet size or particle size of less than about 1000 nm.

Creaming, sedimentation and coalescence, or common destabilization phenomena often are associated with macroemulsions. For consumers, destabilized emulsions may be undesirable for a final product both aesthetically and in meeting specific quality control standards. In some embodiments of the invention, a droplet stabilizer may be added to the emulsions in order to reduce the incidence of creaming and sedimentation. The droplet stabilizer is not a pure substitute for the primary surfactant. Rather, the stabilizer works synergistically with the primary surfactant to provide a physically stable emulsion that retains the high antimicrobial activity of the active compounds.

The droplet stabilizer may be a co-surfactant selected from the same group as the primary surfactant. Preferably, the co-surfactant is also food grade compatible. To maintain non-toxicity and high antimicrobial efficacy, it is preferred to have the total amount of surfactant (surfactant+cosurfactant) fall under the ratio of 10:1 to 3:1 of active component to surfactant and the total concentration of all surfactants be less than 0.1% by weight of the composition. The preferred range by weight of these surfactant co-stabilizers may be from about 0.01% to about 0.06%.

The droplet stabilizer may be also in the form of an acid such as benzoic acid, sorbic acid, malic acid, lactic acid or citric acid. They may be also in the form of a salt such as sodium benzoate, potassium sorbate, sodium citrate, etc. These acid/salts may be used to reduce the effects of drop coalescence and gravitational effects by stabilizing droplet size and minimizing droplet migration. The ideal range of this class of stabilizers may be between about 0.01% to about 0.40% by weight.

The droplet stabilizer also may be in the form of a polysaccharide gum, ester compound or polymeric viscosity enhancer. These include xanthan gum, guar gum, fenugreek gum, gum arabic, carrageenan, agar or polymers such as carbomer, myristyl myristate and the like. These types of droplet stabilizers improve droplet stability by increasing viscosity and reduces the number of collisions between droplets. However, for some uses, the thickening effect is not palatable or acceptable for use. It is therefore recommended that viscosity enhancers or thixotropic stabilizers be used at a low level. The preferred amount of these viscosity enhancers may be in the range of between about 0.005% to about 0.5% by weight of the composition.

The liquid emulsions may be stable over an extended period of time. In some embodiments, the liquid emulsion may withstand boiling, freezing and and/or centrifugation, for example exhibiting nominal changes in emulsion droplet size. In some embodiments, anticipated shelf life may be at least 1 year.

Because active components (e.g., phenolic compounds) are typically available as purified substances, chemical composition of an emulsion may be controlled, facilitating increased predictability in product performance. In some embodiments, formulations may comprise generally recognized as safe (GRAS) components, providing formulations suitable for animal and/or human consumption.

Some embodiments of the invention that include an antimicrobial emulsion may be used in any situation in which the reduction of microorganisms is desired. For example, formulations may be applied to an object for which a reduction in microorganisms is desired in an amount and for a period of time effective to reduce microorganisms. The antimicrobial formulations may be used to disinfect non-porous hard surfaces, including, but not limited to, medical tools and devices, handheld electronics, durable medical equipment, floors, walls, cutting boards, countertops, tabletops, toilet bowls, showers and bathtubs. The antimicrobial formulations may be used to disinfect food items, such as fruits, vegetables, including, for example, leafy green vegetables, and the shell of eggs. The formulations may also be added to animal feed or drinking water as a means to sanitize the water or to selectively alter the gut microbiome. The antimicrobial formulations may be used in personal care products such as cosmetics, antifungal creams, wound care preparations, ophthalmic products, preservatives, toothpaste, oral rinses and denture care products, or in other products that include direct contact with living tissue such as wound preparation. In some embodiments, the antimicrobial emulsion may be used in disinfecting sprays, wipes, agricultural sanitizers, cleansers, and flushes.

In some embodiments of the invention, antimicrobial emulsions may have the ability to reduce microorganism populations on contact with a variety of inanimate surfaces, living tissue and/or in foodstuffs. These microbes may include Gram-positive and/or Gram-negative bacteria, fungus, enveloped viruses, spores and/or endospores. The microorganisms may be loosely adhered to the surface or aggregated in a biofilm. Example formulations effective in reducing microbial populations may comprise an active component, such as a phenolic compound derived from one or more essential oils, a non-ionic or anionic surfactant, a polar solvent, and/or water. Formulations may be manufactured using a self-assembly process, for example emulsions having a sub-micron mean emulsion particle size spontaneously or substantially spontaneously forming when ingredients are combined. The emulsions may be stable across a wide range of temperatures, have long storage life. Further, the emulsions may be non-staining and/or streak free, without leaving oily or soapy residues on surfaces to which the compositions are applied.

In other embodiments of the invention, the antimicrobial emulsions, when delivered in the “ready to use form” or an “end-user form” may advantageously comprise about 0.02% to about 1.00% by weight of an active component, including a monoterpenoid (e.g., thymol, carvacrol, and/or menthol) and/or a polyphenol (e.g., eugenol), a non-ionic or anionic surfactant in which the weight ratio of the active component to surfactant is between about 1:5 and about 30:1, a co-solvent, such as ethanol, at about 0.25% to about 15% by weight, and/or water, for example sufficient water to make up 100% by weight. A concentrated formulation may be manufactured in which the end-user may dilute the concentrated formulation into a desired final concentration. In some embodiments, a concentrated formulation may advantageously include about 1.0% to about 40% by weight of the active component (e.g., a monoterpenoid such as thymol, carvacrol, and/or menthol, and/or a polyphenol such as eugenol), a non-ionic surfactant in which the weight ratio of the active component to the surfactant is between about 1:5 and about 30:1, a co-solvent comprising an organic compound, such as ethanol, at about 10% to about 75% by weight, and/or water, for example sufficient water to make up 100% by weight.

In one certain embodiment of the invention, a formulation, for example used in disinfecting and antiseptic purposes, may include carvacrol between about 0.05% to about 0.10%, by weight. The formulation may have a surfactant, for example a polyoxyethylene 20 cetyl ether (e.g., Brij 58®), at a concentration of about 0.005% to about 0.01%, by weight, a co-solvent, for example an ethanol, at about 1% by weight, and/or water, for example distilled water making up the remaining weight. In some embodiments, a mean emulsion particle size of the formulation may be between about 25 nm to about 500 nm, with a PDI of between about 0.1 to about 0.5.

In one certain embodiment of invention, a formulation, for example used in disinfecting and antiseptic purposes, may include thymol between about 0.05% to about 0.10%, by weight. The formulation may have a surfactant, for example a polysorbate 20, at a concentration of about 0.005% to about 0.01% by weight, a co-solvent, for example an alcohol at about 0.25% to about 2.0%, and/or water, for example distilled water making up the remaining weight. In some embodiments, a mean emulsion particle size may be between about 25 nm to about to about 500 nm, with a PDI of between about 0.1 to about 0.5.

In one certain embodiment of the invention, a formulation, for example used in disinfecting and antiseptic purposes, may include thymol between about 0.05% and about 0.10%, by weight. The formulation may have a surfactant, for example a polyoxyethylene 20 cetyl ether (e.g., Brij 58®), at a concentration of about 0.005% to about 0.01% by weight, a co-solvent, for example an alcohol, at about 0.5% to about 2.0% by weight, and/or water, for example distilled water making up the remaining weight. In some embodiments, a mean emulsion particle size may be between about 25 nm to about 900 nm, with a PDI of between about 0.1 to about 0.5.

In another certain embodiment of the invention, a formulation, for example used in disinfecting and antiseptic purposes, may include thymol between about 0.05% and about 0.10%. The formulation may include a surfactant, for example a sodium dodecyl sulfate, at a concentration of about 0.005% to about 0.01% by weight, a co-solvent, for example an alcohol, at about 0.5% to about 2.0% by weight, and/or water, for example distilled water making up the remaining. In some embodiments, a mean emulsion particle size may be between about 25 nm and about 600 nm, with a PDI of between about 0.1 to about 0.5.

In one certain embodiment of the invention, a formulation, for example used as an animal feed preservative, may include thymol between about 0.005% and about 0.10% by weight. The formulation may include a surfactant, for example a polysorbate 20, at a concentration of about 0.0015% to about 0.1% by weight, a co-solvent, for example an alcohol, at about 0.2% to about 1%, and/or water, for example distilled water making up the remaining weight. In some embodiments, a mean emulsion particle size may be between about 40 nm and about 1000 nm. In some embodiments, the formulation may be mixed into the foodstuffs.

In another certain embodiment of the invention, a formulation, for example used in disinfecting and antiseptic purposes, may include a carvacrol between about 0.05% and about 0.10% by weight. The formulation may include a surfactant, for example a polysorbate 20, at a concentration of about 0.005% to about 0.01% by weight, a co-solvent, for example an alcohol at about 1% by weight, and/or water, for example distilled water making up the remaining weight. In some embodiments, an emulsion particle size may be between about 25 nm and about 900 nm, with a PDI of between about 0.1 and about 0.5.

In certain embodiments of the invention, a chelating agent, such as citric acid and/or ethylenediaminetetraacetic acid (EDTA), may be added to bind metal ions that may be present on the surfaces and/or other targets to which the formulation is applied. Chelators may be intended to enhance the binding affinity of the emulsion to the microorganism and/or be used as a water softening agent.

Certain embodiments of the invention may include more than one monoterpenoid and/or polyphenol combined in an emulsion form. For example, some embodiments may contain thymol at about 0.05% to about 0.10% by weight, and carvacrol at about 0.05% to about 0.10% by weight, mixed with a non-ionic surfactant and an alcohol co-solvent. Variations in the monoterpenoid and/or polyphenol compound type and/or mixture ratios are also envisioned.

In another certain embodiments of the invention, an emulsion, for example used in disinfecting and antiseptic purposes, may include eugenol between about 0.05% and about 0.10% by weight. The formulation may include a surfactant, for example a polysorbate 20, at a concentration of about 0.005% to about 0.01% by weight, a co-solvent, for example an alcohol, at about 0.25% to about 1% by weight, and/or water, for example distilled water to make up the remaining weight. In some embodiments, a mean emulsion particle size may be between about 40 nm and about 1000 nm, with a PDI of between about 0.1 and about 0.5.

In another embodiment of the invention, an emulsion, for example used in disinfecting and antiseptic purposes, may include one or more active components such as thymol between about 0.04% to about 0.20% by weight, methyl salicylate between about 0.02% to about 0.1% by weight, eucalyptol between about 0.01% to about 0.10% by weight, and menthol between about 0.02% to about 0.1% by weight. The formulation may have a surfactant, for example, a Polysorbate 20, at a concentration of about 0.005% to about 0.10%, by weight, a droplet stabilizer, for example, benzoic acid, at about 0.02% to about 0.25% by weight, and/or water, for example distilled water making up the remaining weight.

In one certain embodiment of the invention for use in mouthwashes, an emulsion may contain thymol at 0.064% by weight, methyl salicylate at 0.060% by weight, eucalyptol at about 0.092% by weight, and menthol at about 0.042% by weight. The formulation may contain a surfactant, for example, a Polysorbate 20, at a concentration of about 0.060% by weight, a humectant such as, for example, xylitol at about 2% by weight, and a citrate buffer making up the remaining weight.

In one certain embodiment of the invention for use in mouthwashes, an emulsion may contain thymol at about 0.064% by weight, methyl salicylate at about 0.060% by weight, eucalyptol at about 0.092% by weight, and menthol at about 0.042% by weight. The formulation may contain a surfactant, for example, a Polysorbate 80, at a concentration of about 0.060%, a humectant such as, for example, xylitol at about 2% by weight, and a citrate buffer making up the remaining weight.

In one certain embodiment of the invention for use in mouthwashes, an emulsion may contain thymol at about 0.064% by weight, methyl salicylate at about 0.060% by weight, eucalyptol at about 0.092% by weight, menthone at about 0.030% by weight, and menthol at about 0.042% by weight. The formulation may contain a surfactant, for example, a Polysorbate 80, at a concentration of about 0.080%, a humectant, such as sorbitol, at about 2% by weight, a droplet stabilizer such sodium benzoate and benzoic acid present at about 0.1% each by weight, a second droplet stabilizer such as xanthan gum present at about 0.01% weight, and distilled water making up the remaining weight.

In one certain embodiment of the invention for use in mouthwashes, an emulsion may contain thymol at about 0.064% by weight, methyl salicylate at about 0.060% by weight, eucalyptol at about 0.092% by weight, menthone at about 0.030% by weight, and menthol at about 0.042% by weight. The formulation may contain a surfactant, for example, sodium lauryl sulfate, at a concentration of about 0.10%, a droplet stabilizer such as sodium benzoate and benzoic acid at about 0.1% each by weight, guar gum present at about 0.05% by weight, and distilled water making up the remaining weight.

In one certain embodiment of the invention for use in disinfection, an emulsion may contain thymol at about 0.15% by weight and menthol at about 0.06% by weight. The formulation may contain a surfactant, for example, sodium lauryl sulfate, at a concentration of about 0.10%, a droplet stabilizer of fenugreek gum present at about 0.05% by weight, and buffer solution making up the remaining weight.

In some embodiments of the invention, for example in formulations or emulsions for disinfectant use, sporulating agents may be incorporated into the formulation to facilitate the germination of the spores and/or endospores into vegetative cells. The germinated cells may be subsequently inactivated by the formulation. These germinating agents may include amino acids, sugars, ions and/or enzymes.

In some embodiments of the invention, the organic solvent (e.g., methanol, acetic acid, acetone, butanol, and/or chloroform) and/or the surfactant (e.g., Tween 20®, sodium laureth sulfate, sodium dodecyl sulfate, Brij®, and/or Triton X®) may be changed. Those skilled in the art will recognize that numerous modifications may be made to the specific implementations described above. Some example compositions and corresponding data are shown in Table 1.

In some embodiments of the invention, antimicrobial emulsions may have the ability to reduce microorganism populations on contact with a variety of inanimate surfaces, living tissue and/or in foodstuffs. These microbes may include Gram-positive and/or Gram-negative bacteria, fungus, enveloped viruses, spores and/or endospores. The microorganisms may be loosely adhered to the surface or aggregated in a biofilm matrix. The liquid emulsions may be stable over an extended period of time. In some embodiments, the liquid emulsion may withstand boiling, freezing and and/or centrifugation, for example exhibiting nominal changes in emulsion droplet size. In some embodiments, anticipated shelf life may be at least about 1 year to about 3 years. In some embodiments, these emulsions may be suitable for a variety of commercial applications.

In some embodiments of the invention, a formulation may comprise about 0.02% to about 1.00% by weight of a monoterpenoid (e.g., thymol, carvacrol, and/or menthol) and/or a polyphenol (e.g., eugenol), a non-ionic surfactant in which the weight ratio of the monoterpenoid and/or the phenol to surfactant is between about 1:5 and about 30:1, a co-solvent of organic compound (such as ethanol) at about 0.25% to about 15% by weight, and/or water. A role of the surfactants and/or organic solvent may be to facilitate a spontaneous emulsification process and/or a long-term thermodynamic stability of the emulsion droplets. Active components, such as thymol and carvacrol, are often available as crystalline solids that are mostly insoluble in water. While pure emulsions of these active components may be made, the pure emulsions may be highly unstable, for example phase separating within hours due to an Ostwald ripening process. Phenolic compounds may be soluble in organic solvents, such as ethanol, diethyl ether and/or acetone, although these organic solvents generally may be harsh, toxic, and/or generally not optimal for consumer use as an antiseptic, disinfectant and/or as food additives.

While there are a variety of surfactants and/or emulsifiers that may be used to stabilize emulsions, for example emulsions comprising phenolic based compounds and/or essential oils, surprisingly, some of these combinations may be antagonistic for antimicrobial properties and/or shelf life properties of the emulsions. For example, a combination of thymol with a cationic surfactant, such as benzethonium chloride (which is also highly antimicrobial), may decrease the antibacterial activity of thymol, and/or reduce a shelf life property of the combination, for example, by becoming rancid within about three months. Emulsions comprising about 0.0625% by weight of a thyme oil, combined with polysorbate 80 (e.g., Tween 80®), lauric arginate and/or sodium dodecyl sulfate may show reduced antifungal activity, even though the individual components are antifungal. This is completely unexpected and demonstrates not all surfactants are compatible with essential oil derivatives with respect to antimicrobial properties and/or shelf life properties.

Prior art attempts to extend the shelf life of essential oil-based antimicrobial emulsions by adding Ostwald ripening inhibitors, e.g., medium chain length triglycerides (corn oil), were found to adversely impact antimicrobial properties. For example, inclusion of a medium chain length triglyceride increased the shelf life of thyme based emulsions but drastically reduced the antimicrobial effects of the emulsions.

Unexpectedly, not all surfactants may facilitate formation of thermally stable submicron emulsions (e.g., a mean emulsion droplet diameter of less than about 1000 nm). For example, polyethylene glycol may produce micro and/or macroscale emulsions that may exhibit phase segregation. Furthermore, emulsion droplets in the nanoscale tend to contribute to increase the shelf life of the emulsion, by reducing flocculation, aggregation, creaming and/or sedimentation. In some embodiments, miniemulsions may facilitate improved penetration into the skin and/or into rough surface patches, may be more uniformly distributed in solution, and/or may be less viscous than comparable macroemulsions. The terms “nanoemulsion” and “miniemulsion” are used to define emulsions in which a mean droplet size is between about 25 nm to about 1000 nm, including for example from about 100 nm to about 600 nm.

In some embodiments of the invention, non-ionic surfactants, when combined with phenolic active components, for example in certain ratios, may provide stable self-assembling emulsions, including miniemulsions, which have useful antimicrobial activity. Some example formulations are outlined in Table 1.

In some embodiments of the invention, a formulation may advantageously include an emulsion made with extremely low surfactant concentrations, for example less than about 0.1% by weight. In some embodiments, an emulsion may advantageously include a surfactant at less than about 0.01% by weight. In contrast, many common disinfecting products currently available include surfactant concentrations in the about 3% to about 10% weight range, including for disinfecting products having essential oil concentrations at about 1% by weight. For example, a stable nanoemulsion may be made with a thymol concentration of about 0.063%, a surfactant concentration of about 0.0063% and about 1% of a co-solvent (e.g., ethanol), by weight. Other active components (e.g., a monoterpenoid and/or a polyphenol), and/or other co-solvents (e.g., an organic co-solvent) may be suitable. In some embodiments, an emulsion having such a composition may be surprisingly stable, for example having a monodisperse particle size of −120 nm. In some embodiments, an emulsion having such a composition may withstand centrifugation, boiling and/or freezing without or substantially without significant phase separation. In some embodiments, emulsions of such a composition may demonstrate minimal size change after about three months of shelf life testing. This low surfactant formulation is highly unexpected and demonstrates a unique quasi-static emulsion state. A formulation comprising such a reduced quantity of a surfactant may represent a 10 to 100-fold reduction in the amount of stabilizing surfactant typically used in essential oil products.

In another embodiment of the invention, a formulation may be advantageously incorporated into a hydrocolloid suspension (e.g., a gel system and/or a paste system). For example, a formulation (e.g., a formulation comprising a nanoemulsion) may be mixed into an existing hydrocolloid suspension. A hydrocolloid suspension may include a variety of components, including but not limited to polysaccharides such as xanthan gum, collagen (e.g., gelatin), petrolatum, combinations thereof, and/or the like. In some embodiments, a mixture of the formulation and the hydrocolloid suspension may have a concentration of an active component (e.g., a phenolic active) between about 0.02% and about 0.5% by weight of the final mixture. Mixtures of formulations and hydrocolloid suspensions may be suitable for a variety of applications, including in wound dressing applications, for example facilitating slow release of the formulation and/or creation of an antimicrobial barrier on a target wound surface.

In some embodiments of the invention, water, isotonic saline or a water-based phosphate buffer may be used as the liquid phase carrier, for example with sufficient water to make up 100% by weight of the formulation. Deionized and/or distilled water may be used. A co-solvent may be an organic solvent, including but not limited to, ethanol, methanol, acetone, butanol, chloroform, methyl ethyl ketone, dimethyl sulfoxide (DMSO), ether, carboxylic acids, including, for example, acetic acid or citric acid, and the like, and combinations thereof. A co-solvent may help stabilize the emulsion. Heat energy may be used to form an emulsion where a formulation includes no co-solvent. A formulation for an end-user product may advantageously have a concentration of the co-solvent at less than about 5%, by weight. In some embodiments, a formulation may have a co-solvent at a concentration between about 0.25% to about 1%, by weight. In some embodiments, a formulation may have an increased concentration of a co-solvent, including a concentration of the co-solvent of about 5% to about 50%, by weight, for example to facilitate emulsion stability. The co-solvent may be synthetic and/or naturally extracted. Formulations used in food applications may include an edible co-solvent.

A formulation may include one or more ingredients to enhance the antimicrobial and/or cleaning efficacy of the formulation. For example, a co-surfactant may be used to further improve long-term stability. A chelator, such as ethylenediaminetetraacetic acid (EDTA) and/or citric acid, may be added to bind ions typically found in hard water. These ions may change the surfactant solubility and/or interfere with the antimicrobial activity of the emulsions. A germinating agent may be introduced to destroy dormant spores and/or endospores more effectively. These sporulating agents may encourage the spores to transition into the vegetative cell state, at which point the spore may be more effectively inactivated by the emulsions. These germinating agents may include amino acids, sugars, ions and/or enzymes.

In some embodiments of the invention, a fragrance, scented ingredients, and/or dye may be added to the formulation in order to improve the olfactory characteristics and/or to impart color into the solution. These fragrances may include essential oils and/or their derivatives. Alternatively, scented ingredients and/or fragrances may be synthetic or natural compounds such as those extracted from floral and/or fruit.

In some embodiments of the invention, a zinc compound selected from the group of zinc chloride, zinc gluconate or zinc lactate may be added to the emulsions. These zinc compounds may help with deodorizing and in binding to volatile sulfur based compounds, such as those related to halitosis.

In some embodiments of the invention, a buffer solution may be used as the continuous phase in the emulsion. The buffer may have a pH that is suitable for a particular application. Suitable buffers include a phosphate buffer, citrate buffer, carbonate buffer and the like.

In some embodiments of the invention, a humectant may be included to moisturize the product, especially in dermal related applications. Humectants improve skin feel and aid with water retention. Suitable humectants include sorbitol, xylitol, polyethylene glycol and propylene glycol. Preferably, the concentrations of these humectants should be less than 3% and preferably in the range of about 1% to about 2.5% by weight if used for the purpose of hydration.

A mechanism of antimicrobial activity for a miniemulsion, including a miniemulsion as described herein, may be based on membrane disruption of the target pathogen. As the miniemulsions may be formed from hydrophobic compounds (e.g., monoterpenoids), they may be highly lipophilic. For example, fusion between the miniemulsions and microbial membranes, and/or the partitioning of the membrane lipids may be responsible for disrupting the membrane integrity, causing intracellular leakage of contents and/or cell death. The lack of an oil and/or lipid component in example formulations may enhance the performance of the active components, since the lipid may act to block the phenolic compound from accessing the cell membrane.

In some embodiments of the invention, emulsions as described herein may possess several unique and/or unexpected properties conducive for scale up manufacturing. For example, exemplary formulations with unique ratios of active:surfactant:co-solvent ratio may spontaneously form emulsions (e.g., self-assemble) upon combining the active component, surfactant and co-solvent. Example ranges of ratios and/or concentration ranges include the ratios and/or concentrations as described herein. Outside of the specified exemplary ranges, the mixed components may phase separate (e.g., layering) and/or may not form emulsions. Self-assembly may be driven by favorable thermodynamic conditions. For example, a decrease in surface tension, for example through addition of an appropriate quantity of surfactant, and/or an emulsion having strong interfacial repulsion between emulsion droplets, may facilitate formation of a self-assembling emulsion having extended shelf life properties. Self-assembly may eliminate a need for homogenization, heat application, and/or high pressure and/or high shear processing. This self-assembly process of the emulsion is in direct contrast to currently available nanoemulsion fabrication techniques, which often may require input energy, for example in the form of high frequency sonication and/or homogenization, to form emulsion droplets (e.g., nanosized emulsion droplets). This manufacturing advantage may be especially attractive in the industrial setting, reducing the overall difficulty in scale-up.

In some embodiments of the invention, emulsions having components within the described ratio ranges and/or concentration ranges may be monodisperse (e.g., PDI<0.5), highly stable and/or may be repeatably manufactured. In some embodiments, accelerated and/or real-time shelf life studies show minimal changes in the emulsion droplet size, for example indicating that the emulsion is monodisperse, and/or demonstrating homogeneous size distribution in the emulsion droplet size. Example active components may be environmentally friendly, and/or may degrade very quickly in the soil and/or wastewater run-off.

In some embodiments of the invention, the active component is first heated into liquid form and subsequently added to the aqueous solvent phase and homogenized. In other embodiments, the emulsions are prepared by dissolving the active component into the organic co-solvent, and then mixed with a surfactant and water at the specified concentration ranges. In yet another embodiment, the active component, in a liquid form, may be added to the water/co-solvent/surfactant mix directly and then homogenized.

Table 1 shows non-limiting examples of formulations.

TABLE 1
Example Formulations

| | |
|---|---|
| Component | Weight/Volume (%) |

Example 1: Antimicrobial nanoemulsion

| | |
|---|---|
| Thymol | 0.063 |
| Polysorbate 20 | 0.0063 |
| Ethanol | 1.00 |
| DI Water | 98.9307 |
| Total | 100.00 |

Example 2: Antimicrobial nanoemulsion

| | |
|---|---|
| Thymol | 0.063 |
| Sodium laureth | 0.0063 |
| sulfate | |
| Ethanol | 1.00 |
| Water | 98.9307 |
| Total | 100.00 |

Example 3: Antimicrobial nanoemulsion

| | |
|---|---|
| Carvacrol | 0.063 |
| Polysorbate 20 | 0.0063 |
| Ethanol | 1.00 |
| Water | 98.9307 |
| Total | 100 |

Example 4: Antimicrobial nanoemulsion

| | |
|---|---|
| Thymol | 0.063 |
| Citric acid | 1.00 |
| Polysorbate 20 | 0.0063 |
| Ethanol | 1.00 |
| Water | 97.9307 |
| Total | 100.00 |

Example 5: Antimicrobial nanoemulsion

| | |
|---|---|
| Thymol | 0.064 |
| Methyl salicylate | 0.060 |
| Eucalyptol | 0.092 |
| Menthol | 0.042 |
| Polysorbate 20 | 0.060 |
| Sodium citrate | 0.1728 |
| Citric acid | 0.041 |
| xylitol | 2.0 |
| DI Water | balance |
| Total | 100.00 |

Example 6: Antimicrobial nanoemulsion

| | |
|---|---|
| Thymol | 0.064 |
| Methyl salicylate | 0.060 |
| Eucalyptol | 0.092 |
| Menthol | 0.042 |
| Polysorbate 80 | 0.080 |
| Citric acid | 0.041 |
| Sodium citrate | 0.1728 |
| xylitol | 2.0 |
| DI Water | balance |
| Total | 100.00 |

Example 7: Antimicrobial nanoemulsion

| | |
|---|---|
| Thymol | 0.064 |
| Methyl salicylate | 0.060 |
| Eucalyptol | 0.092 |
| Menthol | 0.042 |
| Polysorbate 80 | 0.080 |
| Menthone | 0.030 |
| Sodium benzoate | 0.10 |
| Benzoic acid | 0.10 |
| Xanthan gum | 0.01 |
| sorbitol | 2.0 |
| DI Water | balance |
| Total | 100.00 |

Example 8: Antimicrobial nanoemulsion

| | |
|---|---|
| Thymol | 0.064 |
| Methyl salicylate | 0.060 |
| Menthol | 0.040 |
| Menthone | 0.030 |
| Sodium Lauryl sulfate | 0.100 |
| Benzoic acid | 0.08 |
| Sodium benzoate | 0.12 |
| Guar gum | 0.05 |
| DI Water | balance |
| Total | 100.00 |

Example 9: Antimicrobial nanoemulsion

| | |
|---|---|
| Thymol | 0.15 |
| Menthol | 0.060 |
| Sodium Lauryl sulfate | 0.100 |
| Benzoic acid | 0.08 |
| Sodium benzoate | 0.12 |
| Fenugreek gum | 0.05 |
| DI Water | balance |
| Total | 100.00 |

### Experimental Examples

Antimicrobial susceptibility and accelerated stability testing of example formulations were conducted to assess emulsion properties. Compositions of the example formulations include a ratio of surfactant to active component as listed in Tables 2-5. In some embodiments, the formulations may include ethanol as a co-solvent. For example, a formulation may include a co-solvent (e.g., ethanol) at about 1% by weight. For stability assessment, the mean droplet size of the emulsion as a function of time and processing was measured via dynamic light scattering. The results of these formulations are presented in Table 2 in the form of emulsion particle size and PDI. The results are shown for embodiments in which the emulsion was diluted to give a concentration of active component of 0.063%; similar droplet sizes may be obtained in higher and lower dilutions of the emulsions. For some embodiments, additional stability processing was conducted, as shown in Tables 3-5. These tests included moderate heating (e.g., heating to about 45° C. for about 48 hrs), a freeze thaw cycle (e.g., cycling a temperature of a formulation from about −21 degree C. (° C.) to about 25° C.), and/or centrifugation (e.g., for about 30 min) at 13000 g of the emulsion system. After post-processing, the emulsion particle size was again investigated to look at potential phase separation and instability.

TABLE 2
Example Formulations

| | | | | Average | |
|---|---|---|---|---|---|
| | | | Ratio of | Emulsion | |
| | | | Surfactant: | Particle Size | |
| ID # | Active | Surfactant | Active | (nm) | PDI |
| 1 | Thymol | Polysorbate 20 | 1:2 | 616 | 0.52 |
| | | (e.g., Tween | | | |
| | | 20 ®) | | | |
| 2 | Thymol | Polysorbate 20 | 1:5 | 139 | 0.46 |
| | | (e.g., Tween | | | |
| | | 20 ®) | | | |
| 3 | Thymol | Polysorbate 20 | 1:10 | 135** | 0.30 |
| | | (e.g., Tween | | | |
| | | 20 ®) | | | |
| 4 | Thymol | Sodium dodecyl | 1:2 | 90 | 0.44 |
| | | sulfate (SLS) | | | |
| 5 | Thymol | SLS | 1:5 | 69 | 0.40 |
| 6 | Thymol | SLS | 1:10 | 157 | 0.29 |
| 7 | Thymol | polyoxyethylene | 1:2 | 223 | 0.44 |
| | | 20 cetyl ether | | | |
| | | (e.g., Brij 58 ®) | | | |
| 8 | Thymol | polyoxyethylene | 1:5 | 257 | 0.53 |
| | | 20 cetyl ether | | | |
| | | (e.g., Brij 58 ®) | | | |
| 9 | Thymol | polyoxyethylene | 1:10 | 162 | 0.74 |
| | | 20 cetyl ether | | | |
| | | (e.g., Brij 58 ®) | | | |
| 10 | Thymol | Polyethylene | 1:2 | *n/a | *n/a |
| | | glycol (e.g., | | | |
| | | PEG 400) | | | |
| 11 | Thymol | Polyethylene | 1:5 | *n/a | *n/a |
| | | glycol (e.g., | | | |
| | | PEG 400) | | | |
| 12 | Thymol | Polyethylene | 1:10 | *n/a | *n/a |
| | | glycol (e.g., | | | |
| | | PEG 400) | | | |
| 13 | Thymol | Octylphenol | 1:2 | *n/a | *n/a |
| | | ethoxylate (e.g., | | | |
| | | Triton X ®) | | | |
| 14 | Thymol | Octylphenol | 1:5 | *n/a | *n/a |
| | | ethoxylate (e.g., | | | |
| | | Triton X ®) | | | |
| 15 | Thymol | Octylphenol | 1:10 | *n/a | *n/a |
| | | ethoxylate (e.g., | | | |
| | | Triton X ®) | | | |
| 16 | Carvacrol | Polysorbate 20 | 1:2 | | |
| | | (e.g., Tween | | | |
| | | 20 ®) | | | |
| 17 | Carvacrol | Polysorbate 20 | 1:5 | | |
| | | (e.g., Tween | | | |
| | | 20 ®) | | | |
| 18 | Carvacrol | Polysorbate 20 | 1:10 | | |
| | | (e.g., Tween | | | |
| | | 20 ®) | | | |
| 19 | Eugenol | Polysorbate 20 | 1:2 | *n/a | *n/a |
| | | (e.g., Tween | | | |
| | | 20 ®) | | | |
| 20 | Eugenol | Polysorbate 20 | 1:5 | *n/a | *n/a |
| | | (e.g., Tween | | | |
| | | 20 ®) | | | |
| 21 | Eugenol | Polysorbate 20 | 1:10 | *n/a | *n/a |
| | | (e.g., Tween | | | |
| | | 20 ®) | | | |

*n/a denotes emulsion size too large to measure with dynamic light scattering or no emulsion formed.
**165 nm with PDI of 0.27 after 3 months storage at 25° C.

TABLE 3
Post Heating of Example Embodiments

| | | | Ratio of | Average | |
|---|---|---|---|---|---|
| | | | Surfactant: | Emulsion Particle | |
| ID # | Active | Surfactant | Active | Size (nm) | PDI |
| 1 | Thymol | Polysorbate 20 | 1:2 | 292 | 0.45 |
| | | (e.g., Tween | | | |
| | | 20 ®) | | | |
| 2 | Thymol | Polysorbate 20 | 1:5 | 108 | 0.53 |
| | | (e.g., Tween | | | |
| | | 20 ®) | | | |
| 3 | Thymol | Polysorbate 20 | 1:10 | 123 | 0.24 |
| | | (e.g., Tween | | | |
| | | 20 ®) | | | |
| 4 | Thymol | SLS | 1:2 | 151 | 0.36 |
| 5 | Thymol | SLS | 1:5 | 153 | 0.46 |
| 6 | Thymol | SLS | 1:10 | 144 | 0.75 |
| 7 | Thymol | polyoxyethylene | 1:2 | *n/d | — |
| | | 20 cetyl ether | | | |
| | | (e.g., Brij 58 ®) | | | |
| 8 | Thymol | polyoxyethylene | 1:5 | *n/d | — |
| | | 20 cetyl ether | | | |
| | | (e.g., Brij 58 ®) | | | |
| 9 | Thymol | polyoxyethylene | 1:10 | *n/d | — |
| | | 20 cetyl ether | | | |
| | | (e.g., Brij 58 ®) | | | |

*n/d denotes no data

TABLE 4
Post Freeze of Example Embodiments

| | | | Ratio of | Average | |
|---|---|---|---|---|---|
| | | | Surfactant: | Emulsion Particle | |
| ID # | Active | Surfactant | Active | Size (nm) | PDI |
| 1 | Thymol | Polysorbate 20 | 1:2 | 202 | 0.41 |
| | | (e.g., Tween | | | |
| | | 20 ®) | | | |
| 2 | Thymol | Polysorbate 20 | 1:5 | 99 | 0.60 |
| | | (e.g., Tween | | | |
| | | 20 ®) | | | |
| 3 | Thymol | Polysorbate 20 | 1:10 | 109 | 0.30 |
| | | (e.g., Tween | | | |
| | | 20 ®) | | | |
| 4 | Thymol | SLS | 1:2 | 244 | 0.21 |
| 5 | Thymol | SLS | 1:5 | 165 | 0.38 |
| 6 | Thymol | SLS | 1:10 | 197 | 0.61 |
| 7 | Thymol | polyoxyethylene | 1:2 | *n/d | — |
| | | 20 cetyl ether | | | |
| | | (e.g., Brij 58 ®) | | | |
| 8 | Thymol | polyoxyethylene | 1:5 | *n/d | — |
| | | 20 cetyl ether | | | |
| | | (e.g., Brij 58 ®) | | | |
| 9 | Thymol | polyoxyethylene | 1:10 | *n/d | — |
| | | 20 cetyl ether | | | |
| | | (e.g., Brij 58 ®) | | | |

*n/d denotes no data

TABLE 5
Post Centrifugation (e.g., for about 30 min) of Example Embodiments

| | | | Ratio of | Average | |
|---|---|---|---|---|---|
| | | | Surfactant: | Emulsion Particle | |
| ID # | Active | Surfactant | Active | Size (nm) | PDI |
| 1 | Thymol | Polysorbate 20 | 1:2 | 432 | 0.46 |
| | | (e.g., Tween | | | |
| | | 20 ®) | | | |
| 2 | Thymol | Polysorbate 20 | 1:5 | 143 | 0.4 |
| | | (e.g., Tween | | | |
| | | 20 ®) | | | |
| 3 | Thymol | Polysorbate 20 | 1:10 | 136 | 0.32 |
| | | (e.g., Tween | | | |
| | | 20 ®) | | | |
| 4 | Thymol | SLS | 1:2 | 152 | 0.26 |
| 5 | Thymol | SLS | 1:5 | 126 | 0.28 |
| 6 | Thymol | SLS | 1:10 | 121 | 0.11 |
| 7 | Thymol | polyoxyethylene | 1:2 | 262 | 0.32 |
| | | 20 cetyl ether | | | |
| | | (e.g., Brij 58 ®) | | | |
| 8 | Thymol | polyoxyethylene | 1:5 | 214 | 0.32 |
| | | 20 cetyl ether | | | |
| | | (e.g., Brij 58 ®) | | | |
| 9 | Thymol | polyoxyethylene | 1:10 | 117 | 0.49 |
| | | 20 cetyl ether | | | |
| | | (e.g., Brij 58 ®) | | | |

In addition to accelerated storage stability treatments, the antimicrobial activity of some embodiments was assessed on a variety of fungus, bacteria and and/or viruses using a time-kill assay under good laboratory practice (GLP) conditions. Table 6 shows a non-exhaustive list of pathogens tested using formulations having the composition of embodiment Example 1, as shown in Table 1. Testing procedures included American Society for Testing and Materials (ASTM) method E1052 (ASTM E1052) suspension test.

TABLE 6
Antimicrobial Testing of Embodiment #1

| | | Colony- | |
|---|---|---|---|
| | | forming | |
| | Contact | units/milliliter | % |
| Microorganism | Time | (CFU/mL) | Reduction |
| B. cereus endospore | Time zero | 5.00E+06 | n/a |
| | 1 minute | 4.00E+06 | 21.569 |
| | 10 minutes | 2.80E+06 | 45.098 |
| C. albicans ATCC 10231 | Time zero | 2.25E+06 | n/a |
| | 1 minute | 2.50E+02 | 99.989 |
| | 10 minutes | <50 | >99.997 |
| E. faecalis (VRE) ATCC | Time zero | 1.17E+06 | n/a |
| 51299 | 1 minute | 3.35E+04 | 97.124 |
| | 10 minutes | 1.50E+06 | 99.987 |
| E. coli ATCC 11229 | Time zero | 3.80E+07 | n/a |
| | 1 minute | 1.42E+04 | 99.963 |
| | 10 minutes | 1.00E+03 | 99.997 |
| P. aeruginosa ATCC | Time zero | 5.20E+07 | n/a |
| 15442 | 1 minute | 3.60E+06 | 93.077 |
| | 10 minutes | 3.40E+04 | 99.935 |
| S. aureus ATCC 6538 | Time zero | 1.47E+07 | n/a |
| | 1 minute | 2.75E+05 | 98.129 |
| | 10 minutes | 8.75E+04 | 99.405 |
| S. aureus (MRSA) ATCC | Time zero | 1.15E+06 | n/a |
| 33592 | 1 minute | 3.00E+02 | 99.974 |
| | 10 minutes | <50 | >99.996 |
| Herpes simplex 1 strain | Time zero | 5.1E+05 | n/a |
| HF | 1 minute | 2.25E+01 | 99.7 |
| | 10 minutes | <1.50E+02 | >99.97 |

Experimental data show multiple miniemulsion embodiments were made that were kinetically stable when subjected to accelerated stability testing. Additionally, some embodiments were tested for antimicrobial activity and were shown to be extremely biocidal within about 1 minute and about 10 minute time spans. These results demonstrate near surfactant-free formulations in which the antimicrobial properties of the native phenolic compound may be preserved in a surprisingly stable manner.

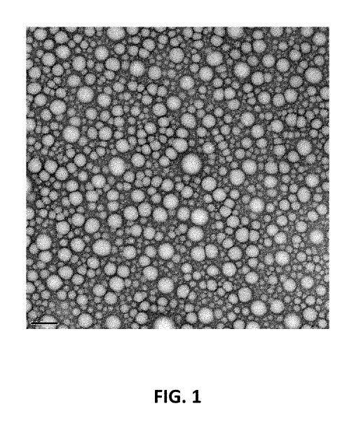

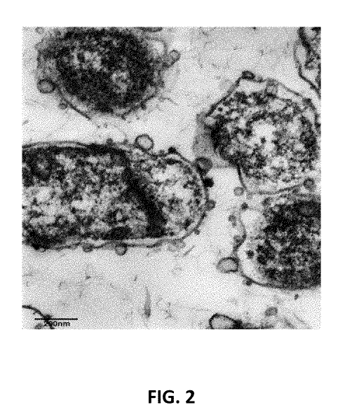

Emulsion ID#3, which contains thymol and polysorbate 20 in a 10:1 ratio, respectively, was evaluated using negative staining transmission electron microscopy (FIG. 1) and was found to have an average emulsion particle size of about 135 nm, as corroborated by dynamic light scattering. The effect of the main active component, thymol, on pathogenic E. coli was visualized using transmission electron microscopy (FIG. 2). With reference to FIG. 2, pathogenic E. coli exposed to a pure thymol emulsion at 0.10% concentration exhibits signs of immediate bacteriolysis and membrane damage. These results clearly demonstrate the membrane perturbing effects of thymol.

In addition to assays that describe the antimicrobial activity of planktonic (free floating) microorganisms, experiments assessing the effects of these emulsions on biofilms were also performed. These tests were conducted on romaine lettuce and blueberries inoculated with several food-borne bacteria in order to simulate agricultural applications. Briefly, these experiments first involved inoculating lettuce and blueberries with E. coli O157:H7, Salmonella spp., and Listeria monocytogenes. The samples were then incubated at room temperature for 1.5 hours to allow for biofilm formation. Following incubation, the lettuce or blueberry samples were exposed to several variants of the emulsion sanitizers for 1 minute. After emulsion treatment, the vegetable/fruit samples were neutralized and homogenized and serially plated onto selective media for pathogen identification and enumeration. These biofilm antimicrobial tests were done at both 25° C. and at 4° C. The experimental data are shown below in Table 7. All emulsions listed were used at 0.10% active thymol concentration:

TABLE 7

| | | | Log | |
|---|---|---|---|---|
| | | Starting Conc. | Reduction | Error |
| | Pathogen | (CFU) | (after 1 min) | (log) |
| Romaine Lettuce | | | | |
| Treatment at 25° C. | | | | |
| Water | Salmonella spp | 1.02E+06 | 0.76 | 0.29 |
| Emulsion ID #3 | Salmonella spp | 1.02E+06 | 1.68 | 0.31 |
| Emulsion ID #6 | Salmonella spp | 1.02E+06 | 1.68 | 0.34 |
| Emulsion #6 w/ 0.2% citric | Salmonella spp | 1.02E+06 | 2.22 | 0.34 |
| acid | | | | |
| Water | E. coli O157:H7 | 1.32E+06 | 1.74 | 0.12 |
| Emulsion #3 | E. coli O157:H7 | 1.32E+06 | 1.82 | 0.26 |
| Emulsion #6 | E. coli O157:H7 | 1.32E+06 | 2.34 | 0.20 |
| Emulsion #6 w/ 0.2% citric | E. coli O157:H7 | 1.32E+06 | 2.36 | 0.14 |
| acid | | | | |
| Water | Listeria | 7.34E+03 | 0.75 | 0.22 |
| | monocytogenes | | | |
| Emulsion #3 | Listeria | 7.34E+03 | 1.55 | 0.23 |
| | monocytogenes | | | |
| Emulsion #6 | Listeria | 7.34E+03 | 1.48 | 0.28 |
| | monocytogenes | | | |
| Emulsion #6 w/ 0.2% citric | Listeria | 7.34E+03 | 1.65 | 0.24 |
| acid | monocytogenes | | | |
| Blueberry Treatment at 4° C. | | | | |
| Water | Salmonella spp | 1.17E+06 | 0.85 | 0.16 |
| Emulsion #3 | Salmonella spp | 1.17E+06 | 2.03 | 0.23 |
| Emulsion #6 | Salmonella spp | 1.17E+06 | 1.71 | 0.25 |
| Emulsion #6 w/ 0.2% citric | Salmonella spp | 1.17E+06 | 2.41 | 0.25 |
| acid | | | | |
| Water | E. coli O157:H7 | 9.22E+05 | 0.78 | 0.10 |
| Emulsion #3 | E. coli O157:H7 | 9.22E+05 | 1.26 | 0.11 |
| Emulsion #6 | E. coli O157:H7 | 9.22E+05 | 1.38 | 0.14 |
| Emulsion #6 w/ 0.2% citric | E. coli O157:H7 | 9.22E+05 | 1.55 | 0.12 |
| acid | | | | |
| Water | Listeria | 3.17E+05 | 1.41 | 0.32 |
| | monocytogenes | | | |
| Emulsion #3 | Listeria | 3.17E+05 | 1.13 | 0.25 |
| | monocytogenes | | | |
| Emulsion #6 | Listeria | 3.17E+05 | 1.32 | 0.26 |
| | monocytogenes | | | |
| Emulsion #6 w/ 0.2% citric | Listeria | 3.17E+05 | 1.88 | 0.21 |
| acid | monocytogenes | | | |
| Blueberry Treatment at 25° C. | | | | |
| Water | Salmonella spp | 1.82E+06 | 1.37 | 0.13 |
| Emulsion #3 | Salmonella spp | 1.82E+06 | 2.06 | 0.21 |
| Emulsion #6 | Salmonella spp | 1.82E+06 | 2.47 | 0.21 |
| Emulsion #6 w/ 0.2% citric | Salmonella spp | 1.82E+06 | 1.95 | 0.21 |
| acid | | | | |
| Water | E. coli O157:H7 | 1.32E+06 | 0.51 | 0.10 |
| Emulsion #3 | E. coli O157:H7 | 1.32E+06 | 1.64 | 0.12 |
| Emulsion #6 | E. coli O157:H7 | 1.32E+06 | 1.56 | 0.21 |
| Emulsion #6 w/ 0.2% citric | E. coli O157:H7 | 1.32E+06 | 1.32 | 0.20 |
| acid | | | | |
| Water | Listeria | 8.29E+05 | 1.41 | 0.25 |
| | monocytogenes | | | |
| Emulsion #3 | Listeria | 8.29E+05 | 2.00 | 0.26 |
| | monocytogenes | | | |
| Emulsion #6 | Listeria | 8.29E+05 | 2.12 | 0.29 |
| | monocytogenes | | | |
| Emulsion #6 w/ 0.2% citric | Listeria | 8.29E+05 | 2.65 | 0.25 |
| acid | monocytogenes | | | |

Results showed that the emulsions had between 1-3 logs (or 90-99.9%) of reduction on food borne biofilms when washed for 1 minute. This treatment was significantly better than washing with water, which generally provided less than 1 log of reduction. The data was consistent on both blueberries and romaine lettuce. These efficacy values are comparable to chlorine based sanitizers used at 10-50 ppm. Moreover, the addition of 0.2% citric acid also slightly improved the antimicrobial effectiveness of the emulsions, suggesting enhanced activity in acidic environments. The emulsions were slightly better performing at room temperature vs 4° C. Overall, the data demonstrate that these emulsions may be used as agricultural sanitizers and in biofilm remediation.

Antimicrobial and stability data of antimicrobial emulsions examples 5-9 were collected according to a modified version of the protocol described in U.S. FDA antiseptic monograph 21 CFR Part 356. Briefly, the antimicrobial solutions are diluted to 80% of the original concentration, using the bacterial inoculum (10% of total volume) and fetal bovine serum (10% of total volume). After 30 seconds or 10 minutes of exposure to the test liquids, the bacterial solutions were neutralized in Dey Engley buffer for 10 minutes and then serially plated. Results are shown in Table 8.

TABLE 8

| | | Example 5 | Example 5 | Example 6 | Example 6 |
|---|---|---|---|---|---|
| | Initial | (log | (log | (log | (log |
| | conc. | reduction, | reduction, | reduction, | reduction, |
| Strain | (CFU/mL) | 30 sec) | 10 min) | 30 sec) | 10 min) |
| Escherichia | 5.5 × 10^{∧}7 | >5.74 | >5.74 | >5.74 | >5.74 |
| coli | | | | | |
| Streptococcus | 4.3 × 10^{∧}7 | 2 | 2.59 | 2 | 2.3 |
| mutons | | | | | |
| Candida | 5 × 10^{∧}6 | 3.96 | >4.7 | 3.53 | >4.7 |
| albicans | | | | | |
| Actinomyces | 1.1 × 10^{∧}7 | 4.7 | >5.0 | 4.22 | >5.0 |
| viscosus | | | | | |

Data from Table 8 demonstrate good efficacy of 99% or greater kill in just a very short 30 second time span, using very high bacterial loads of ˜6-8 logs starting concentration. As expected at longer exposure times (10 min), the kill rate is higher. The short-term kill rates may be further improved when adding a droplet stabilizer. For instance, adding a droplet stabilizer at 0.2% to Example 5 and Example 6 formulations resulted in a >100-fold increase in efficacy (Table 9) to those strains that were harder to eliminate. That is, germs may be eliminated at a rate of >99.9% in 30 seconds or less when employing a droplet stabilizer.

TABLE 9

| | | Example | Example | Example | Example |
|---|---|---|---|---|---|
| | | 5 | 5 | 6 | 6 |
| | | with | with | with | with |
| | | droplet | droplet | droplet | droplet |
| | | stabilizer | stabilizer | stabilizer | stabilizer |
| | | (log | (log | (log | (log |
| | | re- | re- | re- | re- |
| | Initial | duction, | duction, | duction, | duction, |
| Strain | conc. | 30 sec) | 10 min) | 30 sec) | 10 min) |
| Streptococcus | 2.85 × 10^{∧}8 | 3.67 | >6.45 | 3.64 | >6.45 |
| mutons | | | | | |
| Candida | 1.0 × 10^{∧}7 | >5.0 | >5.0 | >5.0 | >5.0 |
| albicans | | | | | |

It is demonstrated that adding a droplet stabilizer not only stabilizes the droplets (enhances shelf-life) by reducing the occurrence of destabilization phenomena, but also the more homogeneous droplet size may increase efficacy by several fold. This finding permits the reduction of active components or stabilizing surfactants to further improve safety.

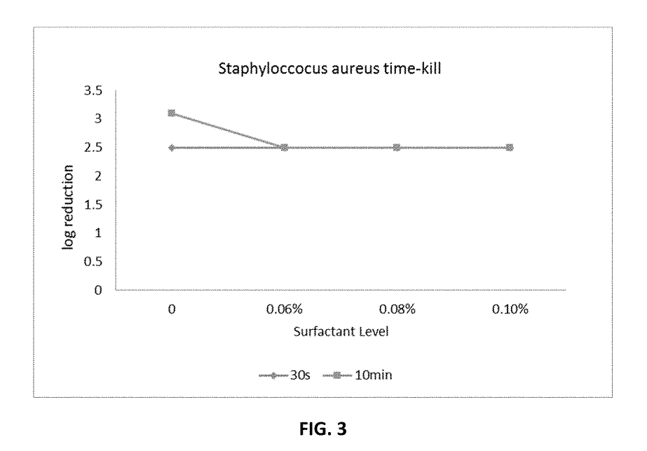

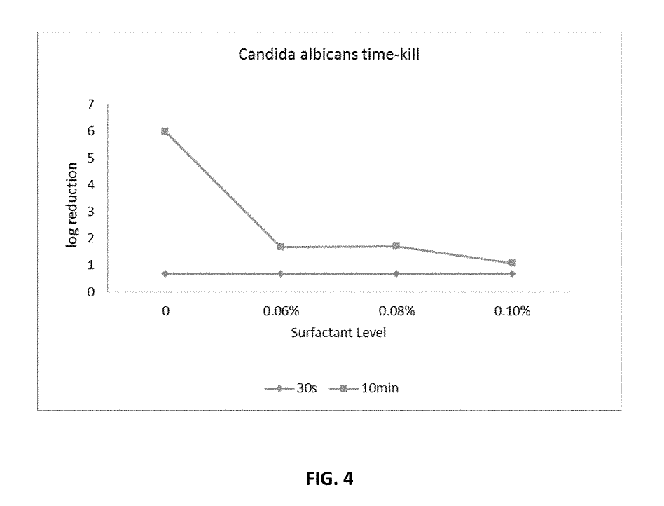

Surprisingly, the concentration of surfactants may have an inhibiting effect on the efficacy of the emulsions. FIG. 3 and FIG. 4 demonstrate that increasing the surfactant level negatively impacts antimicrobial efficacy. This trend is observed with many surfactant types and pathogens, and is an unexpected effect since many surfactants are antimicrobial based on their ability to disrupt cellular membranes. This antagonism and sequestration of the active by the surfactant suggests formulation specific properties and the advantage of using the least amount of surfactant possible. Since reduced surfactants will decrease emulsion stability, it is important to further stabilize the emulsion droplet via other means, such as with a droplet stabilizer, as previously described. The optimum range that provides an efficient balance between ultra-low surfactant content and stabilizer amount may be tuned for each application. However, the invention described herein provides a suitable starting point. It is understood that the invention may be tuned to meet antimicrobial performance criteria as presented.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least +1, 2, 3, 4, 5, 6, 7, 10, 12 or 15%.

Although this disclosure has been provided in the context of certain embodiments and examples, it will be understood by those skilled in the art that the disclosure extends beyond the specifically disclosed embodiments to other alternative embodiments and/or uses of the embodiments and obvious modifications and equivalents thereof. In addition, while several embodiments have been shown and described in detail, other modifications, which are within the scope of this disclosure, will be readily apparent to those of skill in the art based upon this disclosure. It is also contemplated that various combinations or sub-combinations of the specific features and aspects of the embodiments may be made and still fall within the scope of the disclosure. It should be understood that various features and aspects of the disclosed embodiments may be combined with, or substituted for, one another in order to form varying modes of the disclosed embodiments. Thus, it is intended that the scope of the disclosure herein provided should not be limited by the particular embodiments described above. Rather, the intention is to cover all modifications, equivalents, and alternatives falling within the scope of the disclosure as defined by the appended claims.

What is claimed is:

1. A non-irritating antimicrobial emulsion comprising:
thymol;
one or more additional active components selected from the group consisting of limonene, citral, methyl salicylate, eucalyptol, eugenol, carvacrol, menthol, menthone, and geraniol;
a surfactant selected from the group consisting of polysorbates and sodium laureth sulfate;
wherein the ratio of the thymol and the active components to the surfactant is from 10:1 to 3:1 by weight of the emulsion and a total surfactant content is less than 0.1% by weight of the emulsion;
a droplet stabilizer present in a concentration of from 0.005% to 1.0% by weight of the emulsion wherein the emulsion droplet size is from about 200 nm to about 2000 nm; and
water or a buffer solution

2. The antimicrobial emulsion of claim 1, wherein the droplet stabilizer is selected from the group consisting of xanthan gum, guar gum, carrageenan, carbomer, fenugreek gum, and myristyl myristate.

3. The antimicrobial emulsion of claim 1, wherein the droplet stabilizer is selected from the group consisting of sodium benzoate, benzoic acid, potassium sorbate, lactic acid, and malic acid.

4. The antimicrobial emulsion of claim 1, wherein the antimicrobial emulsion is effective against microorganisms selected from the group consisting of Escherichia coli, Candida albicans, Streptococcus mutans, and Actinomyces oris.

5. The antimicrobial emulsion of claim 1, wherein the antimicrobial emulsion inactivates the microorganisms by a factor of greater than or equal to a 3-log reduction within about 30 seconds.

6. The antimicrobial emulsion of claim 1, wherein the thymol and the additional active components are present at a concentration of about 0.005% to about 1%, by weight of the emulsion.

7. The antimicrobial emulsion of claim 1, further comprising one or more co-solvents selected from the group consisting of ethanol, polyethylene glycol, propylene glycol, and poloxamer, each of the co-solvents present at a concentration of 2% or less by weight of the emulsion.

8. The antimicrobial emulsion of claim 7, wherein the antimicrobial emulsion comprises a substantially self-assembling emulsion.

9. The antimicrobial emulsion of any one of claim 1 further comprising a fragrance agent.

10. The antimicrobial emulsion of any one of claim 1 further comprising a zinc compound including zinc chloride, zinc gluconate or zinc lactate

11. The antimicrobial emulsion of any one of claim 1 further comprising a chelating agent including citric acid or ethylene diamine tetraacetate.

12. The antimicrobial emulsion of claim 1 further comprising a humectant, the humectant including of one or more of sorbitol, xylitol, polyethylene glycol, or propylene glycol.

13. The antimicrobial emulsion of claim 1 further comprising an artificial or natural sweetener.

14. The antimicrobial formulation of claim 1 further comprising a spore germinating agent.

15. The antimicrobial emulsion of claim 1, wherein the antibacterial emulsion is used for at least one of a surface disinfectant, an antiseptic preparation for wounds, and an agricultural disinfectant.

16. The antimicrobial emulsion of claim 1, wherein the antibacterial emulsion is implemented in a liquid form.

17. The antimicrobial emulsion of claim 1, wherein the antibacterial emulsion is incorporated into a hydrocolloid suspension.

18. A method for reducing viable microorganisms on an object, comprising contacting an object with an effective amount of the antimicrobial emulsion of claim 1.

19. The method of claim 18, wherein the object is a hard surface, biologic tissue, or a food item.
